(19) United States
(12) Patent Application Publication
(10) Pub. No.: US 2026/0254907 A1
(43) Pub. Date: Aug. 27, 2026

(54) IMAGE PROCESSING SYSTEM, IMAGE PROCESSING METHOD, AND NON-TRANSITORY COMPUTER-READABLE RECORDING MEDIUM

(71) Applicant: Konica Minolta, Inc., Tokyo (JP)

(72) Inventor: Yasutaka Takahashi, Tokyo (JP)

(73) Assignee: Konica Minolta, Inc., Tokyo (JP)

(21) Appl. No.: 19/446,278

(22) Filed: Jan. 12, 2026

(30) Foreign Application Priority Data
Feb. 26, 2025 (JP) 2025-028557

(51) Int. Cl. H04N 1/00; G06T 7/00; H04N 1/10

(52) U.S. Cl. CPC H04N 1/00811; G06T 7/0002; H04N 1/00822; H04N 1/00824; H04N 1/1061; G06T 2207/20081; G06T 2207/30176; H04N 2201/0081

(57) ABSTRACT

An image processing system includes a controller. The controller acquires image data obtained by scanning a document based on a designated scan setting, analyzes the acquired image data and determines whether or not an image defect exists in the acquired image data, determines an attribute of the image defect when it is determined that the image defect exists in the acquired image data, and presents a determination result regarding the attribute of the image defect to user.

### CROSS REFERENCE TO RELATED APPLICATIONS

The present application is based on Japanese Patent Application No. 2025-028557 filed on February 26, 2025, the contents of which are incorporated herein by reference.

### BACKGROUND OF THE INVENTION

### Technical Field

The present invention relates to an image processing system, an image processing method, and a non-transitory computer-readable recording medium.

### Description of Related Art

An image processing apparatus such as an MFP (Multifunction Peripheral) has a scanning function and can read an image of a document to generate image data. Image data read by the scanning function may include image defects such as show-through and streaks.

Conventionally, in order to increase accuracy in detection of a streak included in image data generated by a scanning function, it has been proposed to generate learning data from image data including a streak in an image processing apparatus. This conventional technique is disclosed in, for example, Japanese Unexamined Patent Publication No. JP2021-150856A. In this conventional technique, based on learning data generated by an image processing apparatus, a server apparatus performs learning for detecting a streak and generates a learning model. Next, when newly generating image data with the scanning function, the image processing apparatus inputs the image data to the learning model generated by the server apparatus, thereby detecting streaks of various patterns.

However, image defects included in image data generated by the scanning function include various defects in addition to a streak. For example, show-through that may occur when a double-sided document is scanned is included in the image defect. In addition, image defects such as image collapse, density defect, and blurring may also occur. In the above-described conventional technique, in a case where a streak is included in image data, the streak is detected as image defect. However, the conventional technique cannot appropriately detect an image defect other than a streak.

Incidentally, in a case where an image obtained by the scanning function includes an image defect, there are various causes thereof. For example, among various image defects, there are defects that can be eliminated by changing the scan setting.

However, even when it is determined that an image defect is included in an image obtained by the scanning function, a user cannot recognize how to solve the defect. In particular, even in a case where the defect can be eliminated by changing the scan setting, the user does not know which setting item to change the setting. Therefore, the user has to repeat trial and error for many setting items included in the scan setting, and there is a problem that it takes time to solve the defect.

### SUMMARY OF THE INVENTION

The present invention has been devised in order to solve the above-described conventional problems. That is, an object of the present invention is to provide an image processing system, an image processing method, and a non-transitory computer-readable recording medium capable of, in a case where image data obtained by a scanning function includes an image defect, reducing a user's workload for eliminating the image defect.

One subject of the present invention is directed to an image processing system. According to an aspect of the subject, the image processing system includes a controller. The controller acquires image data obtained by scanning a document based on a designated scan setting, analyzes the acquired image data and determines whether or not an image defect exists in the acquired image data, determines an attribute of the image defect when it is determined that the image defect exists in the acquired image data, and presents a determination result regarding the attribute of the image defect to user.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating a schematic configuration of an image processing system;

FIG. 2 is a block diagram illustrating a functional configuration of an image processing system;

FIG. 3 is a diagram illustrating an example of learning by the learning model generating section;

FIG. 4 is a diagram illustrating a concept of processing by a defect determination section;

FIG. 5 is a diagram illustrating an example of attribute information;

FIG. 6 is a diagram illustrating an example of a preview screen;

FIGS. 7A and 7B are diagrams illustrating an example of a preview screen;

FIG. 8 is a view illustrating an example of a preview screen;

FIG. 9 is a flowchart illustrating an example of a processing sequence in the image processing system;

FIG. 10 is a diagram illustrating an example of attribute information;

FIG. 11 is a flowchart illustrating an example of a processing sequence in the image processing system;

FIG. 12 is a flowchart illustrating an example of a processing sequence in the image processing system; and

FIG. 13 is a flowchart illustrating an example of a detailed processing sequence of the rescan processing.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

### First Embodiment

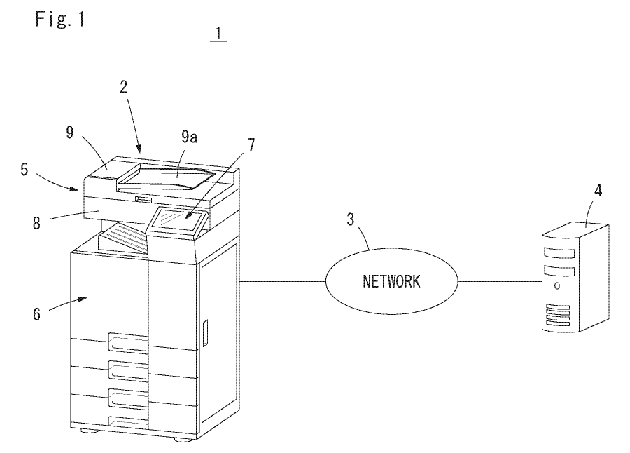

FIG. 1 is a diagram illustrating a configuration example of an image processing system 1 according to the first embodiment of the present invention. As illustrated in FIG. 1, the image processing system 1 has a configuration in which an image processing apparatus 2 and a server apparatus 4 are communicably connected to each other via a network 3. FIG. 1 illustrates a case where the image processing apparatus 2 and the server apparatus 4 are configured as separate apparatuses. However, the embodiment is not limited thereto. For example, functions of the server apparatus 4, which will be described later, may be installed in the image processing apparatus 2.

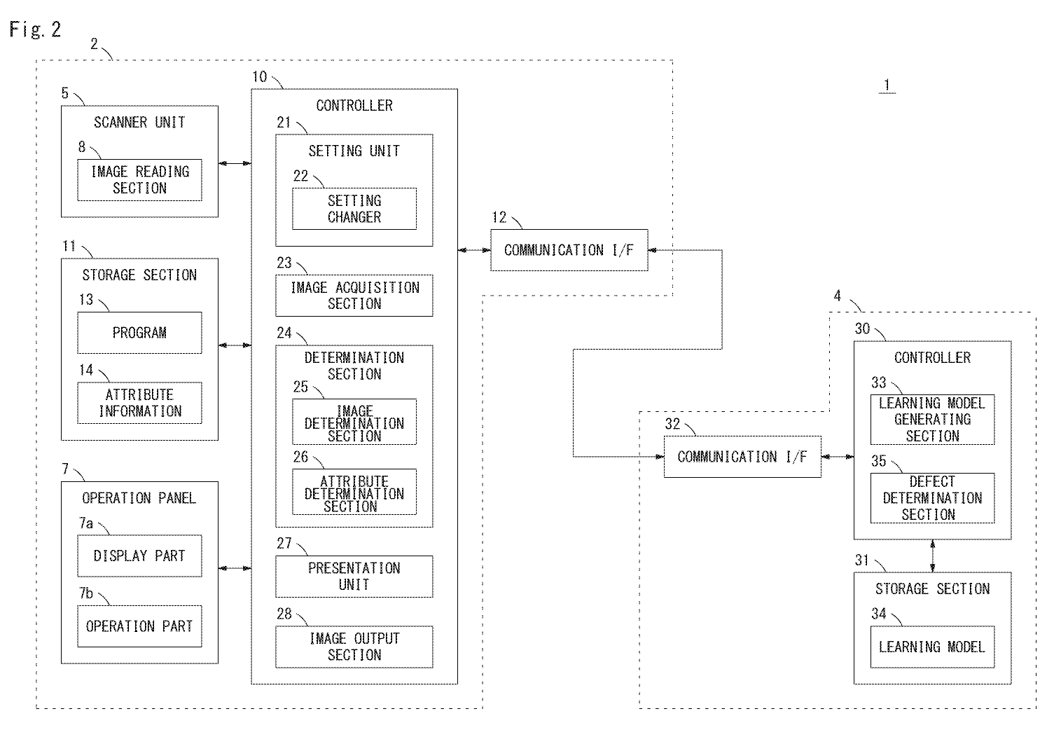

The image processing apparatus 2 is constituted by an MFP, for example. Therefore, the image processing apparatus 2 has a plurality of functions such as a scanning function, a copying function, and a printing function. The image processing apparatus 2 includes a scanner unit 5 in an upper portion of the apparatus body. The scanner unit 5 optically reads an image of a document set by a user and generates image data. The image processing apparatus 2 includes a printer unit 6 at the central portion of the apparatus main body. The printer unit 6 prints and outputs an image on a sheet such as a printing sheet based on image data designated as a print target. Further, the image processing apparatus 2 includes an operation panel 7 on the front side of the apparatus main body. The operation panel 7 is a user interface with which a user uses the image processing apparatus 2. As shown in FIG. 2, the operation panel 7 includes a display part 7a and an operation part 7b. The display part 7a is formed with, for example, a color liquid crystal display, and displays an operation screen that can be operated by a user. The operation part 7b is, for example, a touch screen and receives a user's operation on an operation screen.

The scanner unit 5 includes an image reading section 8 and an automatic document conveyance section 9. The image reading section 8 can read an image by any of a sheet feeder type image reading method and a flatbed type image reading method.

For example, when a document is set on a document tray 9a of the automatic document conveyance section 9, the scanner unit 5 allows the image reading section 8 to perform sheet-feeder type image reading. That is, the scanner unit 5 drives the automatic document conveyance section 9 to automatically convey documents one by one to an image reading position of the image reading section 8. The image reading section 8 reads an image of the document when the document passes through an image reading position, and generates image data.

The automatic document conveyance section 9 can open and close a flatbed type document placement surface provided on top of the image reading section 8. The user can place a document on the document placement surface by lifting the automatic document conveyance section 9. In a case where a document is placed on a flatbed type document placement surface, the scanner unit 5 allows the image reading section 8 to perform flatbed type image reading. That is, the image reading section 8 drives a reading head provided at a position facing the document with the platen glass interposed therebetween, reads an image of the document in a main scanning direction and a sub-scanning direction, and generates image data.

Upon acquiring image data by the scanning function, the image processing apparatus 2 analyzes the image data and determines whether or not an image defect exists. As a result, when there is an image defect, the image processing apparatus 2 presents a method for eliminating the image defect to the user. In the course of such processing, the image processing apparatus 2 is configured to cooperate with the server apparatus 4.

FIG. 2 is a block diagram illustrating a functional configuration of the image processing system 1. The image processing apparatus 2 includes a controller 10, a storage section 11, and a communication interface 12, in addition to the scanner unit 5 and the operation panel 7.

The controller 10 comprehensively controls the operation of the image processing apparatus 2. The controller 10 includes a hardware processor and a memory, which are not illustrated. The hardware processor reads and executes the program 13 stored in the storage section 11. At this time, the hardware processor uses a storage area of the memory as a work area.

The storage section 11 is a nonvolatile storage device constituted by a hard disk drive (HDD) or a solid state drive (SSD). The storage section 11 stores in advance a program 13 to be executed by the hardware processor of the controller 10. The storage section 11 also stores attribute information 14. Details of the attribute information 14 will be described later.

The communication interface 12 connects the image processing apparatus 2 to the network 3 and communicates with an external apparatus connected to the network 3. The controller 10 communicates with the server apparatus 4 via the communication interface 12, and operates in cooperation with the server apparatus 4.

When the hardware processor executes the program 13, the controller 10 functions as a setting unit 21, an image acquisition section 23, a determination section 24, a presentation unit 27, and an image output section 28.

The setting unit 21 performs setting of a job. For example, when the scanning function is selected by the user, the setting unit 21 displays a setting screen related to a scanning job on the display part 7a. The setting unit 21 detects a user's operation on the setting screen via the operation part 7b, and makes scan settings for reading a document. For example, the setting unit 21 sets, for a setting item specified by the user among a plurality of setting items included in the scan settings, a value specified by the user. Furthermore, the setting unit 21 sets, to a predetermined default value, a setting value of a setting item that has not been specified by the user among a plurality of setting items included in the scan settings.

The setting unit 21 includes a setting changer 22. The setting changer 22 changes the scan setting set by the setting unit 21. For example, the setting changer 22 changes at least a part of the scan settings applied at the time of document reading. The setting changer 22 changes the scan setting applied at the time of the previous document reading based on the setting change operation by the user. Furthermore, the setting changer 22 is also capable of automatically changing at least a part of the scan settings applied during the previous reading of the document.

The image acquisition section 23 drives the scanner unit 5 to perform an operation of reading a document (scanning operation) on the basis of a scanning instruction by the user. Next, the image acquisition section 23 acquires image data generated by the image reading section 8 through the document reading operation. That is, the image acquisition section 23 acquires image data obtained by scanning a document by applying the scan setting set by the setting unit 21. When the image acquisition section 23 acquires image data from the image reading section 8, the image acquisition section 23 provides the image data to the determination section 24.

The determination section 24 makes various determinations on the basis of the image data acquired by the image acquisition section 23. The determination section 24 includes an image determination section 25 and an attribute determination section 26.

The image determination section 25 analyzes the image data acquired by the image acquisition section 23, and determines whether or not an image defect exists in the image data. For example, the image determination section 25 cooperates with the server apparatus 4 to determine whether or not image defect exists in the image data, and acquires the determination result.

Here, a configuration of the server apparatus 4 will be described. As described above, the server apparatus 4 cooperates with the image determination section 25 to determine whether or not image defect exists in the image data. Therefore, the server apparatus 4 functions as part of the image determination section 25.

The server apparatus 4 includes a controller 30, a storage section 31, and a communication interface 32. The controller 30 includes a hardware processor and a memory, which are not illustrated. The hardware processor reads and executes a predetermined program, and thus the controller 30 functions as the learning model generating section 33 and the defect determination section 35. The storage section 31 is a nonvolatile storage device constituted by a hard disk drive (HDD) or a solid state drive (SSD). The storage section 31 stores the learning model 34 generated by the learning model generating section 33. The communication interface 32 connects the server apparatus 4 to the network 3, and communicates with an external apparatus connected to the network 3. The controller 30 communicates with the image processing apparatus 2 via the communication interface 32 and operates in cooperation with the image processing apparatus 2.

The learning model generating section 33 learns the learning data including the image data in which the image defect does not exist and the image data in which the image defect exists, and generates the learning model 34 for detecting the image defect included in the image data.

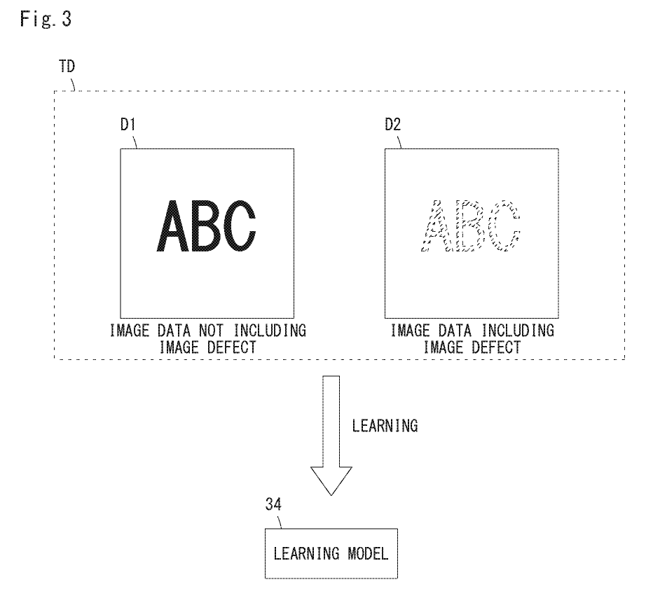

FIG. 3 is a diagram illustrating an example of learning by the learning model generating section 33. For example, the learning model generating section 33 inputs the image data D1 including no image defect and the image data D2 including the image defect as the learning data TD. For example, the image data D1 and D2 are generated from the same image. The image data D1 does not include an image defect, and therefore indicates a normal image. On the other hand, the image defect of "image collapse" exists in the image data D2, and the image quality is lower than that of the image data D1. Note that the image data D1 and D2 may be actually generated by the image reading section 8, or may be intentionally generated by an apparatus different from the image reading section 8. Furthermore, image defects included in the image data D2 include, in addition to image collapse, density failure, show-through, blur, streaks, scanning failure, and the like.

The learning model generating section 33 compares the image data D1 and D2 included in the learning data TD illustrated in FIG. 3, and learns the aspect of the image defect included in the image data D2. Then, the learning model generating section 33 generates the learning model 34 based on the learning result. The learning model generating section 33 generates the learning model 34 capable of detecting various patterns of image defects included in the image data generated by the image reading section 8 by learning various learning data TD in advance. Furthermore, when the learning model generating section 33 acquires and learns new learning data TD, it can also update an existing learning model 34 on the basis of the learning result.

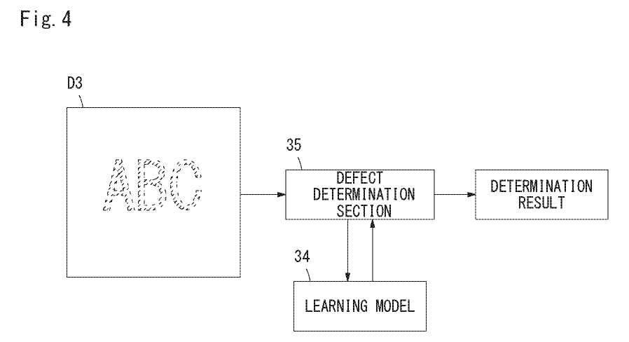

The defect determination section 35 functions when image data which is a detection target of an image defect is acquired. When acquiring image data to be a detection object of an image defect, a defect determination section 35 determines whether or not the image defect exists in the image data. FIG. 4 is a diagram illustrating a concept of processing by the defect determination section 35. Upon acquiring an image data D3 from which an image defect is to be detected, the defect determination section 35 reads the learning model 34 from the storage section 31. Then, the defect determination section 35 determines whether or not there is an image defect in the image data D3 by inputting the image data D3 to the learning model 34, and outputs the determination result.

When an image defect exists in the image data D3, the defect determination section 35 identifies the content of the image defect. The details of the image defect include image collapse, density failure, show-through, blur, streak, scanning failure, and the like. For example, as shown in FIG. 4, when the image data D3 includes the image defect of "image collapse", the defect determination section 35 specifies that the image defect of "image collapse" exists in the image data D3. The content of the identified image failure includes the determination result output from the defect determination section 35.

Returning to FIG. 2. The image determination section 25 sends the image data acquired by the image acquisition section 23 to the server apparatus 4 via the communication interface 12 and requests the defect determination section 35 to make a defect determination. Thus, the defect determination section 35 inputs the image data acquired by the image acquisition section 23 to the learning model 34, and determines whether or not an image defect exists in the image data. The defect determination section 35 transmits the determination result to the image determination section 25 via the communication interface 32. As described above, the image determination section 25 according to the present embodiment determines, in cooperation with the server apparatus 4, whether or not image defect exists in the image data acquired by the image acquisition section 23, and acquires the determination result.

Note that the image determination section 25 may have the built-in function of the server apparatus 4 described above. In this case, the image determination section 25 can determine whether or not there is an image defect in the image data and acquire the determination result without performing communication via the network 3.

When no image failure exists in the image data acquired by the image acquisition section 23, the image determination section 25 ends the processing by the determination section 24. In this case, the image processing apparatus 2 executes normal processing after acquisition of image data in the scan job. For example, the image processing apparatus 2 displays, on the display part 7a, a preview image based on the image data acquired by the image acquisition section 23, and outputs the image data to a destination specified by the user.

On the other hand, when an image defect exists in the image data acquired by the image acquisition section 23, the image determination section 25 causes the attribute determination section 26 in the determination section 24 to function.

When the image determination section 25 determines that an image defect exists, the attribute determination section 26 determines the attribute of the image defect. The image defect has two attributes, that is, a defect that can be solved by changing the scan setting and a defect that cannot be solved by changing the scan setting. The attribute determination section 26 determines which of the two attributes an image defect present in the image data has. Further, when the attribute determination section 26 determines, as the attribute of the image defect, that the defect is likely to be solved by changing the scan setting, the attribute determination section 26 specifies a setting item whose setting is to be changed to solve the defect.

When determining the attribute of the image defect, the attribute determination section 26 reads the attribute information 14 from the storage section 11. The attribute determination section 26 determines the attribute of the image defect based on the attribute information 14 and the determination result by the image determination section 25.

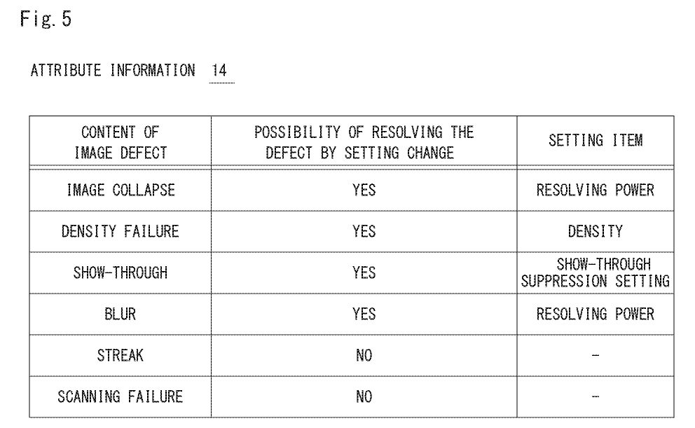

FIG. 5 is a diagram illustrating exemplary attribute information 14. As illustrated in FIG. 5, the attribute information 14 is information in which the content of an image defect, the possibility of resolving the defect by a setting change, and setting items are associated with each other. The column of the content of the image defect includes all the contents of the plurality of image defects specified by the defect determination section 35. In the column of the possibility of resolving the failure by the setting change, whether or not the defect can be resolved by the setting change of the scan setting is defined for each of the contents of the image defect specified by the defect determination section 35. For example, in a case where the defect can be solved by the setting change, "YES" is described in the column of the possibility of solving the defect. In contrast, in a case where the defect cannot be eliminated by the setting change, "NO" is described in the column of the possibility of elimination of defect. In the column of the setting item, in a case where the defect can be solved by changing the setting, the setting item for solving the defect is described. Therefore, the attribute determination section 26 can determine whether or not the image defect identified by the image determination section 25 can be solved by changing the scan setting by referring to the attribute information 14 as shown in FIG. 5. Further, in a case where the defect can be solved by changing the scan setting, the attribute determination section 26 can specify the setting item to be changed by referring to the attribute information 14.

When the determination processing for the image data acquired by the image acquisition section 23 is completed, the determination section 24 brings the presentation unit 27 into operation.

The presentation unit 27 presents the determination result by the determination section 24 to the user. For example, the presentation unit 27 presents the presented information to the user by displaying the presented information on the display part 7a. However, the presentation method by the presentation unit 27 is not limited to this. For example, the presentation unit 27 may provide the presentation information to the user by voice, or may provide the presentation information by transmitting the presentation information to an external device such as a portable terminal.

For example, when the determination processing by the determination section 24 ends, the presentation unit 27 generates a preview screen for displaying a preview image based on the image data. Then, the presentation unit 27 displays the preview screen on the display part 7a. For example, when a setting item whose setting should be changed for eliminating an image defect is specified by the attribute determination section 26, the presentation unit 27 generates a preview screen prompting the user to change the scan setting, and displays the preview screen on the display part 7a.

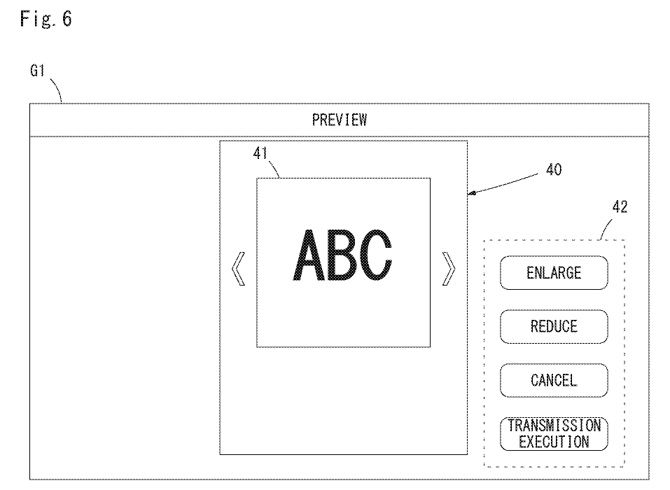

FIGS. 6 to 8 are diagrams illustrating examples of the preview screen G1 displayed by the presentation unit 27. FIG. 6 illustrates the preview screen G1 in a case where it is determined that no image defect exists in data of an image acquired by a scan job. The preview screen G1 includes, at its center, a preview area 40 in which a preview image based on the image data acquired by the scan job is displayed. In the preview area 40, a normal preview image 41 having no image defect is displayed. Furthermore, an operation button group 42 that can be operated by the user is displayed on the right side of the preview area 40. By performing an operation on the operation button group 42, the user can enlarge or reduce the preview image 41 and check details of the preview image 41. In addition, the user can give an instruction to stop or continue processing image data by performing an operation on the operation button group 42.

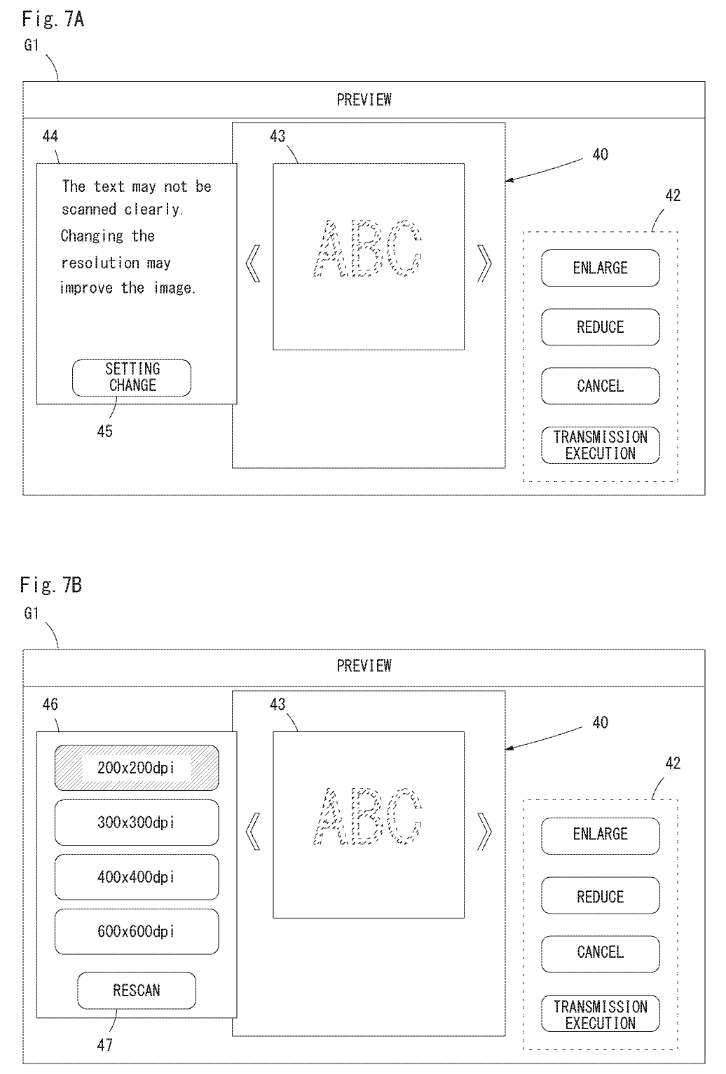

FIGS. 7A and 7B illustrate the preview screen G1 in a case where the image defect can be solved by changing the scan setting. When an image defect exists in the image and the image defect is solved by changing the scan setting, the presentation unit 27 displays a preview screen G1 as illustrated in FIG. 7A. That is, the presentation unit 27 displays the preview image 43 based on the image data in which the image defect exists in the preview area 40. For example, the preview image 43 includes an image defect of image collapse.

The presentation unit 27 also displays a message display field 44 in a display area adjacent to the preview area 40. The message display field 44 displays a message indicating that there is an image defect in the image data acquired by the scan job and that there is a possibility that the image defect will be solved by changing the scan setting. Furthermore, a setting change button 45 that can be operated by the user is displayed in the message display field 44.

When the setting change button 45 is operated by the user, the presentation unit 27 causes the preview screen G1 shown in FIG. 7A to transition to the preview screen G1 shown in FIG. 7B. In other words, the presentation unit 27 switches the message display field 44 to the button display field 46. The button display field 46 illustrated in FIG. 7B displays a plurality of operation buttons for changing a setting value of a setting item for eliminating image defect. The user can change the scan setting by performing an operation on any of the plurality of operation buttons.

For example, the preview screen G1 of FIG. 7B displays the button display field 46 for changing the setting of the resolving power, and the current resolving power is "200 x 200dpi". By performing an operation on the button display field 46, the user can change the setting of the resolution at the time of reading a document to a resolution higher than the current resolution.

When a change operation of the scan setting by the user is performed, a setting changer 22 functions in the setting unit 21. Then, the setting changer 22 changes the scan setting on the basis of a setting change operation by the user.

The button display field 46 displays a rescan button 47. When the rescan button 47 is operated after the change of the scan setting by the user, the image acquisition section 23 functions. The image acquisition section 23 drives the scanner unit 5 to perform reading operation of the document on the basis of a re-scanning instruction by the user. At this time, the reading operation of the document is performed in a state where the setting change by the setting changer 22 is applied. Therefore, the image acquisition section 23 can acquire the image data in which the image defect is eliminated.

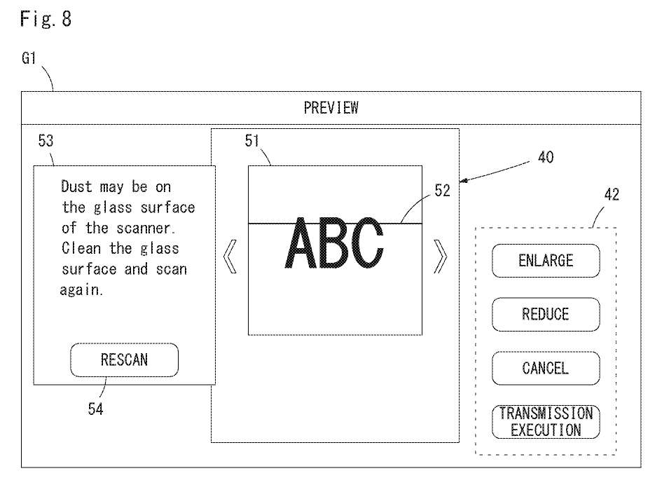

Incidentally, an image defect included in image data might not be cleared by a change in scan setting. In this case, the presentation unit 27 displays the preview screen G1 illustrated in FIG. 8. The preview screen G1 in FIG. 8 displays the preview image 51 including the streak 52 in the preview area 40. In a case where the image defect is the streak 52, the defect is not solved only by changing the scan setting. For example, when the streak 52 occurs in the image data, dust often adheres to the glass surface of the image reading section 8. Therefore, when the image defect present in the image data is a streak, the presentation unit 27 displays a message display field 53 prompting the user to perform cleaning or maintenance. Thus, the user can remove the cause of the image defect by performing cleaning and maintenance.

The message display field 53 displays a rescan button 54. When the rescan button 54 is operated after cleaning or maintenance by the user, the image acquisition section 23 functions. The image acquisition section 23 drives the scanner unit 5 to perform reading operation of the document on the basis of a re-scanning instruction by the user.

Returning to FIG. 2. The image output section 28 functions when a user gives an instruction to output image data. Next, the image output section 28 outputs the image data to an output destination specified by the user. For example, when it is designated to transmit image data obtained by a scan job to an external device, the image output section 28 transmits the image data to the external device via the communication interface 12. When print output is specified, the image output section 28 outputs the image data to the printer unit 6.

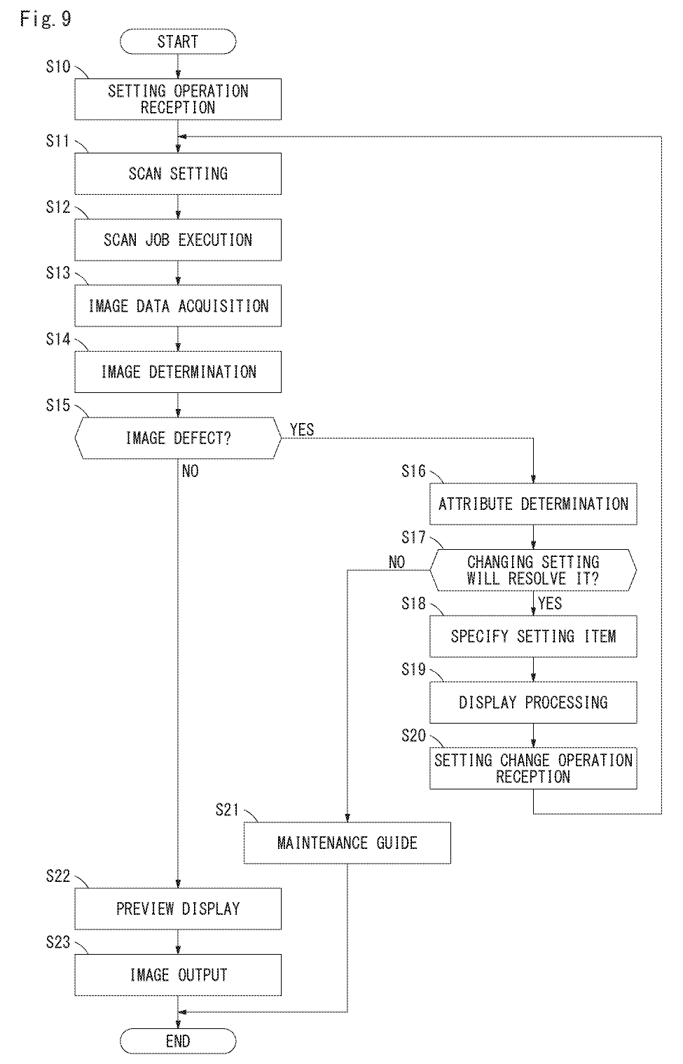

Next, a processing procedure in the image processing system 1 will be described. FIG. 9 is a flowchart illustrating an example of a processing procedure in the image processing system 1. This processing is mainly performed by the controller 10 of the image processing apparatus 2.

The image processing apparatus 2 receives a user's operation for setting a scan job (step S10). Then, the image processing apparatus 2 performs scan setting for document reading by reflecting the setting value designated by the user (step S11). Thereafter, the image processing apparatus 2 executes the scan job based on the scan instruction by the user (step S12). That is, the image processing apparatus 2 performs an operation of reading an image of a document set by a user. As a result, the image processing apparatus 2 acquires an image obtained by scanning the document based on the designated scan setting (step S13).

Upon acquiring the image data obtained by scanning the document, the image processing apparatus 2 analyzes the image data and makes an image determination as to whether or not an image defect exists (step S14). At this time, the image processing apparatus 2 cooperates with the server apparatus 4 to perform image analysis using the learning model 34 and determine whether image defect exists in the image data. As a result, if there is an image defect (YES in step S15), the image processing apparatus 2 determines the attribute of the image defect (step S16). Next, the image processing apparatus 2 determines, based on the result of the attribute determination, whether the image defect will be solved by the change of the scan setting (step S17).

If the image defect is to be cleared by changing the scan setting (YES in step S17), the image processing apparatus 2 specifies, from among the plurality of setting items included in the scan setting, a setting item to be changed to clear the image defect (step S18). The image processing apparatus 2 then displays the preview screen G1 on the display part 7a (step S19). For example, the image processing apparatus 2 displays the preview screen G1 illustrated in FIG. 7A and 7B on the display part 7a. Therefore, the user can easily grasp the setting item for eliminating the image defect and can immediately perform an appropriate setting change operation. Thereafter, the image processing apparatus 2 receives a setting change operation by the user for changing the scan setting (step S20).

When a setting change operation is performed by the user, the processing by the image processing apparatus 2 returns to step S11. That is, the image processing apparatus 2 changes the scan setting applied in the last scanning on the basis of the setting change operation by the user, and executes the processing in step S11 and subsequent steps again in order to perform rescanning.

On the other hand, when the image defect is not solved by the change of the scan setting (NO in step S17), the image processing apparatus 2 guides the user to perform maintenance (step S21). At this time, the image processing apparatus 2 displays, for example, a preview screen G1 as illustrated in FIG. 8 on the display part 7a. Therefore, a user can promptly perform appropriate maintenance for eliminating the image defect.

As a result of the image determination (step S14), when there is no image defect in the image (NO in step S15), the image processing apparatus 2 displays the preview screen G1 on the display part 7a (step S22). At this time, the image processing apparatus 2 displays the preview screen G1 as illustrated in FIG. 6 on the display part 7a. In response to detection of the user's instruction to output an image, the image processing apparatus 2 outputs the image obtained by scanning the document to the destination specified by the user (step S23). Thus, the processing by the image processing apparatus 2 ends.

As described above, the image processing system 1 according to the present embodiment acquires image data obtained by scanning a document on the basis of specified scan settings. The image processing system 1 analyzes the acquired image data and determines whether there is an image defect. When it is determined that there is an image defect, the image processing system 1 further determines the attribute of the image defect. Through the attribute determination, it is determined whether or not the image defect is eliminated by changing the scan setting. The image processing system 1 then presents the determination results to the user. When image data obtained by scanning a document includes an image defect, the image processing system 1 configured as described above automatically determines whether or not the image defect can be solved by changing the scan setting and presents the determination result to the user, thereby reducing the burden on the user.

### Second Embodiment

Next, a second embodiment of the present invention will be described. In the first embodiment, an example of the processing in a case where an image defect exists in image data obtained by scanning a document and the image defect is solved by changing the scan setting has been described. That is, the image processing system 1 of the first embodiment presents a setting item whose setting is to be changed to the user and receives a setting change operation by the user. In contrast, in the present embodiment, an example will be described in which the scan setting is automatically changed in the image processing system 1. A configuration example of the image processing system 1 according to the present embodiment is the same as that described in the first embodiment.

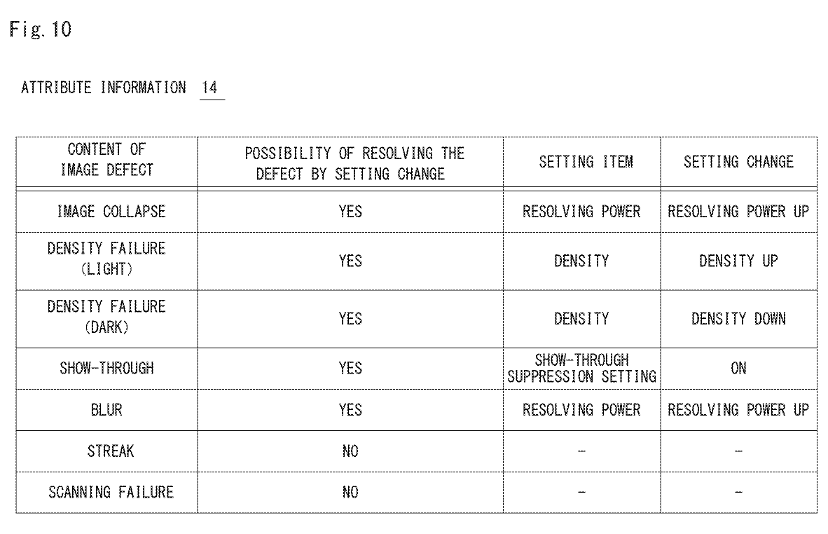

The image processing system 1 of the present embodiment stores attribute information 14 different from that of the first embodiment in the storage section 11. FIG. 10 is a view illustrating an example of the attribute information 14. As illustrated in FIG. 10, the attribute information 14 is information in which the content of an image defect, the possibility that the defect will be solved by a setting change, setting items, and setting changes are associated with each other. The content of the image defect, the possibility of defect resolution by a setting change, and the setting items are the same as those in the attribute information 14 illustrated in FIG. 5. In the column of setting change, the content of the setting change for the setting item indicated in the column of setting item is defined. Therefore, by referring to the attribute information 14, the image processing apparatus 2 can identify the setting item whose setting is to be changed to solve the image defect and the content of the setting change for the setting item.

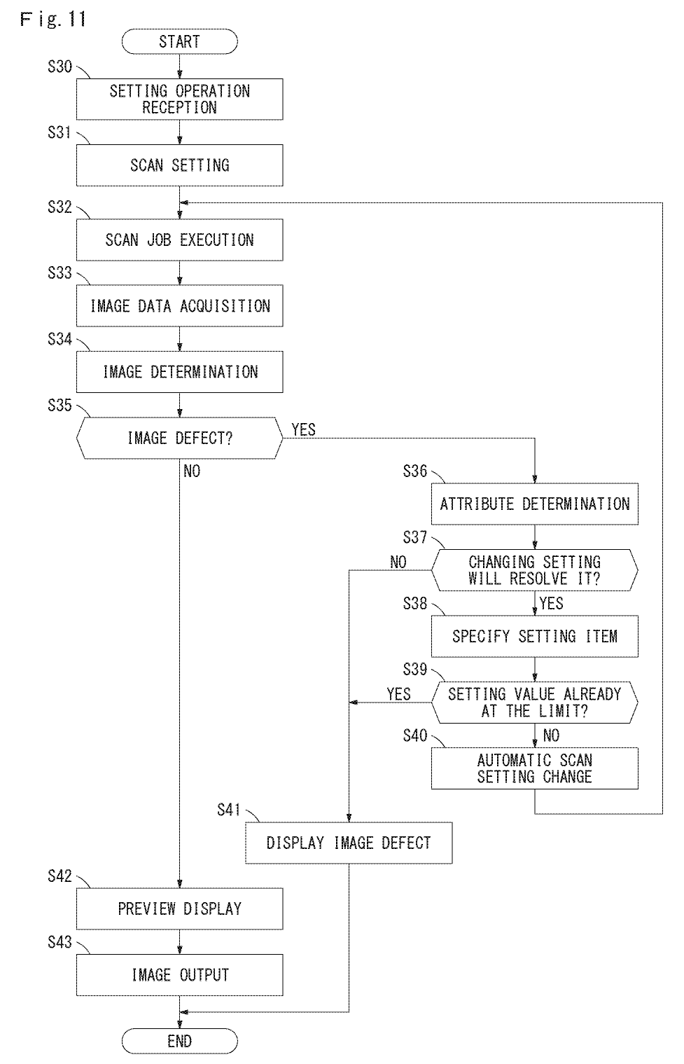

FIG. 11 is a flowchart illustrating an example of a processing procedure in the image processing system 1. This processing is mainly performed by the controller 10 of the image processing apparatus 2. Furthermore, this processing is applicable to a case where a document is placed on a flatbed type document placement surface in the image processing apparatus 2.

The image processing apparatus 2 receives a user's operation for setting a scan job (step S30). Then, the image processing apparatus 2 performs scan setting for document reading by reflecting the setting value designated by the user (step S31). Thereafter, the image processing apparatus 2 executes the scan job based on the scan instruction by the user (step S32). Then, the image processing apparatus 2 acquires an image obtained by scanning the document based on the designated scan setting (step S33).

Upon acquiring the image data obtained by scanning the document, the image processing apparatus 2 analyzes the image data and performs image determination on whether or not there is an image defect (step S34). At this time, the image processing apparatus 2 cooperates with the server apparatus 4 to perform image analysis using the learning model 34 and determine whether image defect exists in the image data. As a result, if there is an image defect (YES in step S35), the image processing apparatus 2 determines the attribute of the image defect by referring to the attribute information 14 shown in FIG. 10 (step S36). Next, the image processing apparatus 2 determines, based on the result of the attribute determination, whether the image defect will be solved by the change of the scan setting (step S37).

If the image failure is to be cleared by changing the scan setting (YES in step S37), the image processing apparatus 2 specifies, from among the plurality of setting items included in the scan setting, a setting item to be changed to clear the image defect (step S38). The image processing apparatus 2 reads the setting value of the specified setting item and determines whether or not the setting value has already reached the limit value (step S39). If the setting value has not reached the limit value (NO in step S39), the image processing apparatus 2 automatically changes the setting value of the specified setting item based on the attribute information 14 (step S40). Thus, the scan setting for the next document reading is automatically changed. Thereafter, the processing by the image processing apparatus 2 returns to step S32. That is, the image processing apparatus 2 automatically executes the scan job again by applying the automatically changed scan setting. As described above, when the document is placed on the flatbed type document placement surface, it is not necessary to prompt the user to set the document again. Therefore, the image processing apparatus 2 can automatically execute rescan promptly after automatically changing the scan setting.

On the other hand, when the image defect is not solved by the change of the scan setting (NO in step S37), the image processing apparatus 2 displays, to the user, that the image defect exists in the image data (step S41). If the set value has already reached the limit value (YES in step S39), the image processing apparatus 2 displays the presence of an image defect in the same manner as described above (step S41).

As a result of the image determination (step S34), when there is no image defect in the image (NO in step S35), the image processing apparatus 2 displays the preview screen G1 on the display part 7a (step S42). In response to detection of the user's instruction to output an image, the image processing apparatus 2 outputs the image obtained by scanning the document to the destination specified by the user (step S43). Thus, the processing by the image processing apparatus 2 ends.

In the processing procedure as described above, the image processing apparatus 2 may repeatedly perform the processing of steps S32 to S40. For example, when the image defect can be solved by increasing the resolution at the time of reading the document, the image processing apparatus 2 changes the setting of the resolution to be higher step by step. Then, every time the scan setting is changed, the image processing apparatus 2 executes the scan job and determines whether or not an image defect exists in the image data acquired by the scan job. Therefore, the image processing apparatus 2 can solve the image defect by repeatedly executing the processing of steps S32 to S40. At this time, since the image processing apparatus 2 does not require user's operation, the change of the scan setting and the re-acquisition of the image data can be automatically repeated. Therefore, the image processing apparatus 2 can acquire image data having no image defect while reducing the burden on the user.

### Third Embodiment

Next, a third embodiment of the present invention will be described. For example, it is preferable that the learning model 34, which is used when it is determined whether or not image defect exists in the image data, is updated successively. Therefore, in the third embodiment, an example in which the learning model 34 is updated using image data in which an image defect exists and image data in which an image defect does not exist as learning data will be described. A configuration example of the image processing system 1 according to the present embodiment is the same as that described in the first embodiment.

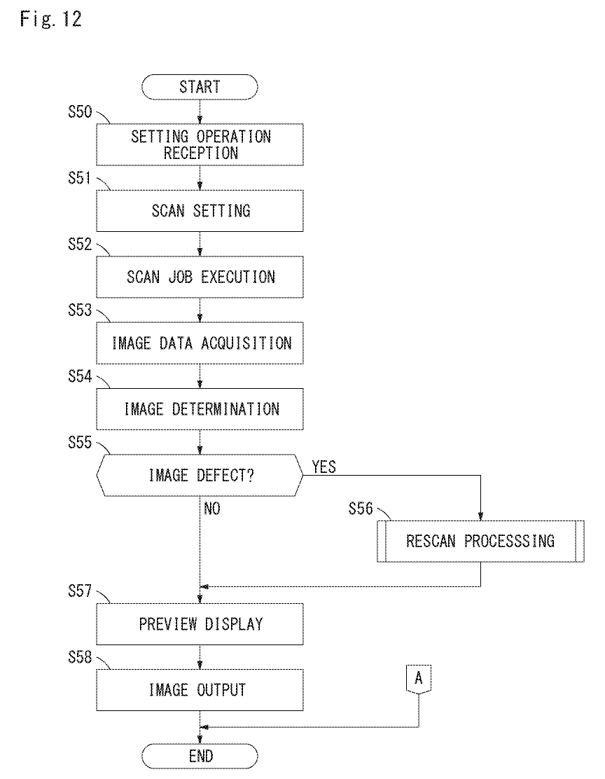

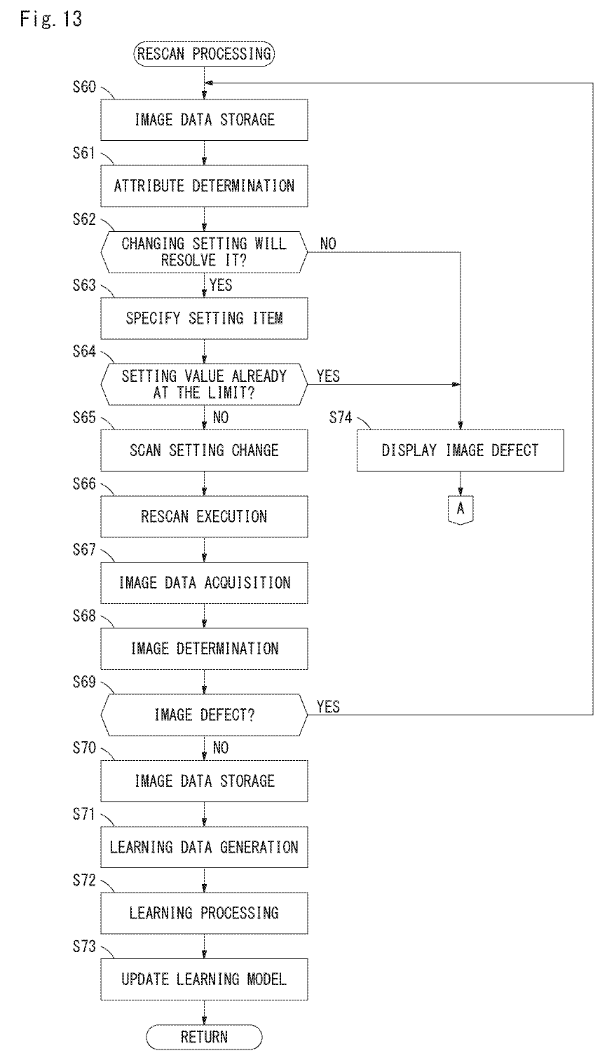

FIGS. 12 and 13 are flowcharts illustrating an example of a processing procedure in the image processing system 1. This processing is mainly performed by the controller 10 of the image processing apparatus 2. As in the second embodiment, this process is applicable to a case where a document is placed on a flatbed document placement surface in the image processing apparatus 2.

The image processing apparatus 2 receives a scan job setting operation performed by the user (step S50). Then, the image processing apparatus 2 performs scan setting for document reading by reflecting the setting value designated by the user (step S51). Thereafter, the image processing apparatus 2 executes the scan job based on the scan instruction by the user (step S52). Then, the image processing apparatus 2 acquires an image obtained by scanning the document based on the designated scan setting (step S53).

Upon acquiring the image data obtained by scanning the document, the image processing apparatus 2 analyzes the image data and makes an image determination as to whether or not an image defect exists (step S54). At this time, the image processing apparatus 2 cooperates with the server apparatus 4 to perform image analysis using the learning model 34 and determine whether image defect exists in the image data. As a result, when there is an image defect in the image (YES in step S55), the image processing apparatus 2 executes a rescanning process (step S56).

If no image defect exists (NO in step S55), the image processing apparatus 2 displays the preview screen G1 in the display part 7a (step S57). In response to detection of the user's instruction to output an image, the image processing apparatus 2 outputs the image obtained by scanning the document to the destination specified by the user (step S58).

FIG. 13 is a flowchart illustrating an example of a detailed processing procedure of the rescanning processing (step S56). At the start of the rescanning process, the image processing apparatus 2 temporarily stores the image data acquired in the last scanning in the storage section 11 or the like (step S60). Thereafter, the image processing apparatus 2 refers to the attribute information 14 illustrated in FIG. 10 to determine the attribute of the image defect (step S61). Next, the image processing apparatus 2 determines, based on the result of the attribute determination, whether the image defect will be solved by the change of the scan setting (step S62). When the image defect is not solved by the change of the scan setting (NO in Step S62), the image processing apparatus 2 displays to the user that the image defect exists in the image (Step S74).

If the image defect is to be cleared by changing the scan setting (YES in step S62), the image processing apparatus 2 specifies, from among the plurality of setting items included in the scan setting, a setting item to be changed to clear the image defect (step S63). The image processing apparatus 2 reads the setting value of the specified setting item, and determines whether the setting value has already reached the limit value (step S64). If the setting value has already reached the limit value (YES in step S64), the image processing apparatus 2 cannot change the setting to solve the image defect. Therefore, in this case, the image processing apparatus 2 displays, to the user, a message indicating that there is an image defect (step S74).

On the other hand, when the setting value does not reach the limit value (NO in step S64), the image processing apparatus 2 automatically changes the setting value of the specified setting item based on the attribute information 14 (step S65). Thus, the scan setting for the next document reading is automatically changed.

After changing the scan setting, the image processing apparatus 2 performs rescanning (step S66). The image processing apparatus 2 acquires the image data generated by the rescanning (step S67).

Upon acquiring the image data by the rescanning, the image processing apparatus 2 analyzes the image data and makes an image determination as to whether or not an image defect exists (step S68). Also at this time, the image processing apparatus 2 cooperates with the server apparatus 4 to perform image analysis using the learning model 34 and determine whether image defect exists in the image data. As a result, when an image defect exists in the image (YES in step S69), the process by the image processing apparatus 2 returns to step S60. Then, the image processing apparatus 2 repeats the processes in and after step S60. Thus, the image defect is solved.

When there is no image defect in the re-scanned image (NO in step S69), the image processing apparatus 2 stores the image having no image defect in the storage section 11 or the like (step S70). Thereafter, the image processing apparatus 2 reads the image data stored in step S60 and the image data stored in step S70, and generates learning data including the image data (step S71). Next, the image processing apparatus 2 transmits the learning dataset to the server apparatus 4, and causes the server apparatus 4 to perform learning processing based on the learning dataset (step S72). At this time, the server apparatus 4 brings the learning model generating section 33 into operation to execute learning processing for detecting image defect on the basis of the learning data acquired from the image processing apparatus 2.

After causing the server apparatus 4 to perform the learning process, the image processing apparatus 2 causes the server apparatus 4 to update the learning model 34 (step S73). Therefore, the learning model generating section 33 of the server apparatus 4 updates the learning model 34 using the learning result based on the learning data. Thus, the rescan processing ends.

That is, when the image defect is solved by changing the scan setting, the image processing system 1 of the present embodiment updates the learning model 34 by using the learning data in which the image data including the image defect and the image data not including the image defect are combined. Therefore, the image processing system 1 can sequentially update the learning model 34 for detecting an image defect. Then, with the sequential updating of the learning model 34, the image processing system 1 can gradually increase the accuracy of determining whether or not an image defect exists.

### Modification Example

A preferred embodiment of the present invention has been described above. However, the present invention is not limited to the content described in the above embodiment, and various modification examples are applicable.

For example, in a case where the function of the server apparatus 4 described above is installed in the image processing apparatus 2, the image processing system 1 is configured only by the image processing apparatus 2. The image processing system 1 may have such a configuration.

Furthermore, in the above-described embodiment, an example has been described in which the learning model 34 is used when it is determined whether or not an image defect exists in image data acquired by the scanning function. However, the learning model 34 may not be used when determining whether or not an image defect exists. For example, the image processing system 1 may determine whether there is an image defect in the image data by performing general known image analysis.

Furthermore, in the above-described embodiment, the program 13 to be executed on the image processing apparatus 2 is stored in advance in the storage section 11. However, the program 13 can be a transaction object by itself. Therefore, the program 13 may be a program that is installed in the image processing apparatus 2 as necessary. In this case, the program 13 is provided in a downloadable form via a network such as the Internet, for example. The program 13 is provided in a form of being recorded in a non-transitory computer-readable recording medium such as a CD-ROM or a USB memory. The program 13 may be provided in any other manner.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing system, comprising a controller that:
acquires image data obtained by scanning a document based on a designated scan setting;
analyzes the acquired image data and determines whether or not an image defect exists in the acquired image data;
determines an attribute of the image defect when it is determined that the image defect exists in the acquired image data; and
presents a determination result regarding the attribute of the image defect to user.

2. The image processing system according to claim 1, wherein
the controller determines, as the attribute of the image defect, whether the image defect is an image defect that is likely to be solved by a change in scan setting or an image defect that is not solved by a change in scan setting.

3. The image processing system according to claim 2, wherein
the controller identifies a setting item whose setting is to be changed, when determining that the image defect is likely to be solved by a change in scan setting.

4. The image processing system according to claim 3, wherein
the controller displays the identified setting item on a predetermined display part and prompts the user to change the scan setting.

5. The image processing system according to claim 4, wherein
the controller reacquires image data obtained by scanning the document based on the scan setting changed by the user.

6. The image processing system according to claim 3, wherein
the controller acquires the image data by scanning the document placed on a flatbed type document placement surface, automatically changes the scan setting by rewriting a setting value of the identified setting item, and reacquires image data by re-scanning the document placed on the flatbed type document placement surface after the scan setting is automatically changed.

7. The image processing system according to claim 6, wherein
the controller repeatedly executes a process of automatically changing the scan setting and reacquiring image data until it is determined that there is no image defect.

8. The image processing system according to claim 1, wherein
the controller determines whether or not the image defect exists in the image data by inputting the image data obtained by scanning the document to a learning model that has learned an image in which an image defect exists and an image in which an image defect does not exist.

9. The image processing system according to claim 8, wherein
the controller generates the learning model, and
when it is determined that the image defect does not exist in the image data reacquired after the scan setting is changed, the controller learns the image data in which the image defect exists before the scan setting change and the image data in which the image defect does not exist after the scan setting change, and updates the learning model.

10. An image processing method including:
acquiring image data obtained by scanning a document based on a designated scan setting;
analyzing the acquired image data and determining whether or not an image defect exists in the acquired image data;
determining an attribute of the image defect when determining that the image defect exists in the acquired image data; and
presenting a determination result regarding the attribute of the image defect to user.

11. The image processing method according to claim 10, wherein
determining the attribute of the image defect includes determining whether the image defect is an image defect that can be solved by changing the scan setting or an image defect that cannot be solved by changing the scan setting.

12. The image processing method according to claim 11, further including:
identifying a setting item whose setting is to be changed, when determining that the image defect can be solved by a change in scan setting.

13. The image processing method according to claim 12, further including:
displaying the identified setting item on a predetermined display part; and
prompting the user to change the scan setting.

14. The image processing method according to claim 13, further including:
reacquiring image data obtained by scanning the document based on the scan setting changed by the user.

15. The image processing method according to claim 12, wherein
acquiring the image data is performed by scanning the document placed on a flatbed type document placement surface, and
the method further includes automatically changing the scan setting by rewriting a setting value of the identified setting item, and reacquiring image data by re-scanning the document placed on the flatbed type document placement surface after the scan setting is automatically changed.

16. The image processing method according to claim 15, wherein
the process of automatically changing the scan setting and reacquiring the image data is repeatedly executed until it is determined that there is no image defect.

17. The image processing method according to claim 10, further including:
determining whether or not the image defect exists in the image data by inputting the image data obtained by scanning a document to a learning model that has learned an image in which an image defect exists and an image in which an image defect does not exist.

18. The image processing method of claim 17, further including:
generating the learning model;
learning the image data in which the image defect exists before the scan setting change and the image data in which the image defect does not exist after the scan setting change, when it is determined that the image defect does not exist in the image data reacquired after the scan setting is changed; and
updating the learning model.

19. A non-transitory computer-readable recording medium storing a program to be executed in an image processing apparatus that generates image data by scanning a document, the program causing the image processing apparatus to perform:
acquiring image data obtained by scanning a document based on a designated scan setting;
analyzing the acquired image data and determining whether or not an image defect exists in the acquired image data;
determining an attribute of the image defect when determining that the image defect exists in the acquired image data; and
presenting a determination result regarding the attribute of the image defect to user.
